(19) United States
(12) Patent Application Publication
(10) Pub. No.: US 2009/0171691 A1
(43) Pub. Date: Jul. 2, 2009

(54) SYSTEM AND METHOD FOR A WEB-BASED SOCIAL NETWORKING DATABASE

(75) Inventors: DAN LUBARSKI, WATERTOWN, MA (US); SERGEY PORFIRIEV, NEWTON, MA (US); SERGEY PRAZDNICHKOV, MOSCOW (RU)

Correspondence Address: AKC PATENTS, 215 GROVE ST., NEWTON, MA, 02466, US

(73) Assignee: HUMANBOOK, INC., WELLESLEY HILLS, MA (US)

(21) Appl. No.: 12/343,117

(22) Filed: Dec. 23, 2008

Related U.S. Application Data
(60) Provisional application No. 61/017,465, filed on Dec. 28, 2007.
(60) Provisional application No. 61/017,452, filed on Dec. 28, 2007.
(60) Provisional application No. 61/017,408, filed on Dec. 28, 2007.
(60) Provisional application No. 61/022,633, filed on Jan. 22, 2008.

(51) Int. Cl. G06Q 99/00; G06F 17/30

(52) U.S. Cl. 705/1; 707/104.1; 707/E17.044

(57) ABSTRACT

An online system and a method for a web-based social networking database that allows collaborative updating of the social network information. The method includes creating profile templates for each person within a group and storing these profile templates in a central database. Next, populating the profile templates with publicly available basic information and then publishing the public profile information in the web-based social network application. Users login into the social network application, update their profile information and upload their personal social network information. The system then cross-correlates and matches the social network information from the users' personal profiles to the social network information listed in other persons' profiles. The personal social network information includes names, contact information, pictures and stories of the users' personal contacts.

### CROSS REFERENCE TO RELATED CO-PENDING APPLICATIONS

This application claims the benefit of U.S. provisional application Ser. No. 61/017,465 filed on Dec. 28, 2007 and entitled SYSTEM AND METHOD FOR A WEB-BASED SOCIAL NETWORKING DATABASE which is commonly assigned and the contents of which are expressly incorporated herein by reference.

This application is also related and claims the benefit of U.S. provisional application Ser. No. 61/017,452 filed on Dec. 28, 2007 and entitled SYSTEM AND METHOD FOR A WEB-BASED ADDRESS BOOK which is commonly assigned and the contents of which are expressly incorporated herein by reference.

This application is also related and claims the benefit of U.S. provisional application Ser. No. 61/017,408 filed on Dec. 28, 2007 and entitled SYSTEM AND METHOD FOR A WEB-BASED PEOPLE DIRECTORY which is commonly assigned and the contents of which are expressly incorporated herein by reference.

This application is also related to and claims the benefit of U.S. provisional application Ser. No. 61/022,633 filed on Jan. 22, 2008 and entitled SYSTEM AND METHOD FOR A WEB-BASED PEOPLE PICTURE DIRECTORY which is commonly assigned and the contents of which are expressly incorporated herein by reference.

### FIELD OF THE INVENTION

The present invention relates to a system and a method for a web-based social networking database, and in particular to an online social networking database that allows collaborative updating of the social network information.

### BACKGROUND OF THE INVENTION

Social networks are social structures comprising individuals or organizations that are connected to each other by similar ethnic or cultural origin, educational history and background, profession, interests, hobbies, trade, political views, values, visions, ideas, conflicts, financial interests and activities, friends, problems, religion or any other personal or behavioral characteristic. Referring to FIG. 1, a schematic diagram of a social network 60 includes individuals 62, 72, 78, 73, 77, 71, 75, 79 or organizations 74, 76 connected to each other via connections or relationships 64, 66. The connections may be direct or indirect. In this example, individual 62 has direct connections 64 to individual 72 and organizations 74 and 76 and indirect connections to all other individuals 78, 77, 73, 75, 71 and 79.

The emergence of the virtual community of the World Wide Web (www) has allowed people to communicate with other people online and to form online social networking groups without any location boundaries. Examples of such online social networking groups include www.facebook.com, www.MySpace.com, www.friendster.com, www.linkedIn.com, and online alumni network of people who attended a specific college or university. For each group member a profile is created and stored in a database. A group member accesses his profile by logging into the group's website via a user identification and password and enters and/or modifies his profile information content. Access to the user's profile by other network members is controlled by the user. These prior art systems rely upon each group member actively managing and updating his online profile content and social networking information. However, this usually does not happen. Therefore the retrieved profile and social networking information may be wrong, outdated and in general not reliable. Furthermore, there is no way for correcting the published information by anyone else but the member and the information is only available to the members of a specific group.

Accordingly, there is a need for an online system and method for a social networking database that allows collaborative updating of the social networking information.

### SUMMARY OF THE INVENTION

In general, in one aspect, the invention features a computer implemented method for an online social network including the following. First, generating a profile template for each person within a group and storing them in a central database and then populating each person's profile template with publicly available information. Next, publishing each person's profile template through a web-based social network application executing on a first computing device. The web-based social network application is adapted to be accessed by a first person of the group through a browser executing on a second computing device. The second computing device is adapted to connect to the first computing device via a network connection. Next, providing a first webpage adapted to be viewed by the first person via the browser for the first person to login into the web-based social network application and to search the first person's own profile template in the central database. Next, retrieving the first person's own profile template and displaying it in a second webpage adapted to be viewed by the first person through the browser. Next, uploading the first person's personal social network information and adding the uploaded personal social network information to the first person's profile template. The personal social network information comprises names, contact information, pictures and stories of the first person's personal contacts. Next, cross correlating the uploaded personal social network information of the first person with information in the profile templates of the first person's personal contacts and updating the first person's personal contacts' profile templates.

Implementations of this aspect of the invention may include one or more of the following features. The profile template has one or more fields including last name, first name, address, age, date of birth, phone number, e-mail address, education background, work address, personal address book, personal contacts and photographs. The method further includes selecting one or more of the fields to be publicly displayed in the profile template. The method further includes updating the first person's profile information by the first person. The method further includes displaying the updated profile template and uploaded personal address book of the first person in the second webpage. The method further includes verifying and updating the first person's profile information by other persons of the group. The method further includes updating the contact information of the first person's personal contacts in the first person's personal address book based on information in the personal contact's profile templates. The method further includes inviting the first person's personal contacts to join the web-based address book application, verify information in their personal profile templates and then upload their personal address books. The method further includes generating a profile template for an uploaded personal contact of the first person when none exist in the central database. The second computing device may be a computer, a mobile phone, a pager, a television remote control, a PDA or combinations thereof. The group may be a group of people residing in a certain geographic area, a group of people belonging to a certain organization, or a group of all people on earth. The publicly available information may be data from telephone directories, business directories, marketing data, financial data or other legally accessible data. Each person's profile information may be verified by answering preset questions formulated based on group common knowledge. The method further includes grouping together into subgroups persons with the same field parameters. The method further includes providing communication tools for communications between the persons within the group or the subgroups.

In general, in another aspect, invention features a computer system comprising a first computing device, a storage device, profile templates for each person on earth stored in a central database stored in the storage device and a web-based social network application stored in the storage device. The web-based social network application includes a first webpage adapted to be viewed by a first person through a browser executing on a second computing device and a second webpage. The second computing device is adapted to connect to the first computing device via a network connection. The first webpage prompts the first person to log in the web-based social network application and to search the first own person's profile template stored in the central database. The second webpage displays the first person's retrieved profile template and includes means for the first person to update the first person's profile information, means for uploading the first person's personal social network information, means for adding the updated profile information and uploaded personal social network information to the first person's profile template, means for cross-correlating the uploaded personal social network information of the first person's personal contacts with information in the profile templates of the first person's personal contacts and means for updating the personal contacts' profile templates. The personal social network information includes names, contact information, pictures and stories of the first person's personal contacts.

In general, in another aspect, invention features an interactive web-based social network application stored in a first computing device and adapted to be accessed by a first person via a second computing device connecting to the first computing device via a network connection. The web-based social network application includes a first webpage adapted to be viewed by the first person through a browser executing on the second computing device and a second webpage also adapted to be viewed by the first person through the browser. The first webpage prompts the first person to login into the web-based social network application and to search the first person's own profile template stored in a central database. The second webpage displays the first person's profile template and includes means for the first person to update the first person's profile information, means for uploading the first person's personal social network information, means for adding the updated profile information and uploaded personal social network information to the first person's profile template, means for cross-correlating the uploaded personal social network information of the first person's personal contacts with information in the profile templates of the first person's personal contacts and means for updating the personal contacts' profile templates. The personal social network information includes names, contact information, pictures and stories of the first person's personal contacts.

In general, in another aspect, invention features a display device including first and second graphical user interfaces. The first graphical user interface includes a first row and a control. The first row comprises a prompt to a first person to login into a web-based social network application and to search the first person's own profile template stored in a central database. Actuation of the control initiates the searching and retrieval of the first person's profile template. The second graphical user interface includes one or more rows displaying the first person's retrieved profile template and additional controls. Activation of the additional controls allows the first person to update information in the first person's profile template, to upload the first person's personal social network information, to add the updated profile information and uploaded personal social network information to the first person's profile template, to cross-correlate the uploaded personal social network information of the first person's personal contacts with information in the profile templates of the first person's personal contacts and to update the personal contacts' profile templates. The personal social network information includes names, contact information, pictures and stories of the first person's personal contacts.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 depicts a schematic diagram of a social network;

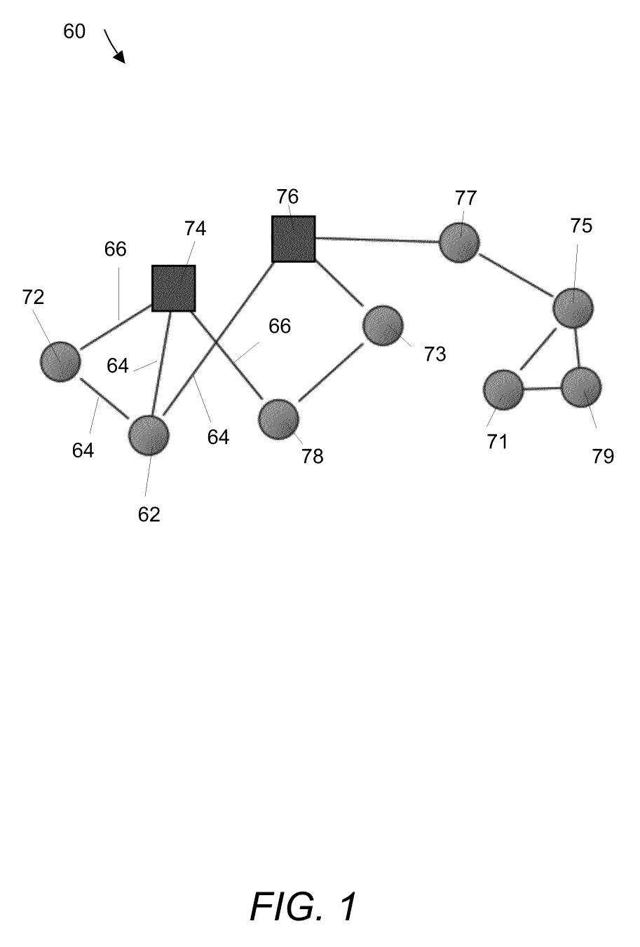

FIG. 2 is an overview diagram of an online social network system according to the present invention;

FIG. 3 is a schematic diagram of the database of FIG. 2;

FIG. 4 depicts a profile template as stored in the database of FIG. 3;

FIG. 5 illustrates the process of creating the collaborative social networking database of this invention; and

FIG. 6 depicts a schematic diagram of the matrix of shared connections.

### DETAILED DESCRIPTION OF THE INVENTION

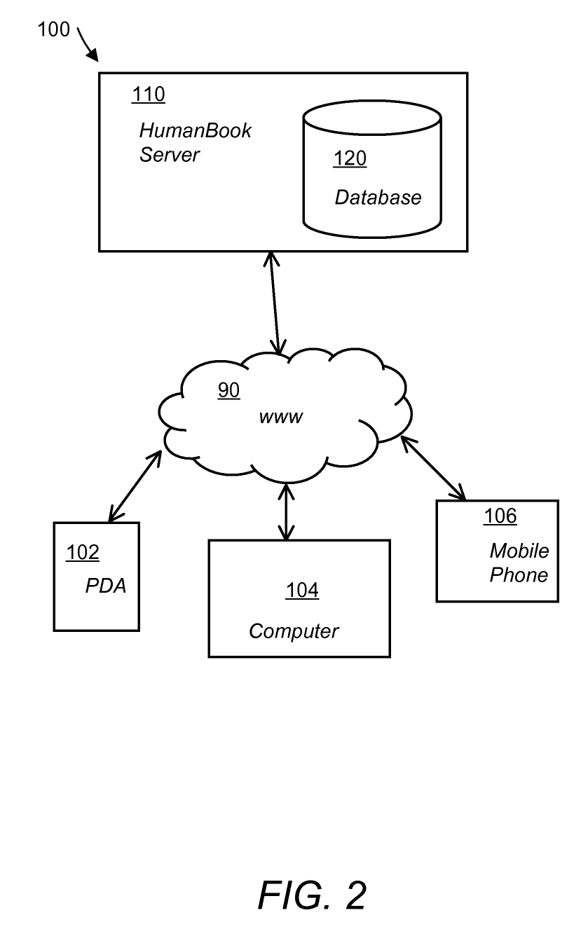

Referring to FIG. 2, a web-based social network 100 includes a database 120, a server 110 and communication devices 102, 104, 106. The communication devices include a Personal Digital Assistant (PDA) 102, a computer 104, and a mobile phone 106. In other examples, the communication devices may be wired or wirelesses devices including a pager, a wireless laptop computer, a personal computer, a television remote control, or combinations thereof. The communication devices access the server 110 and database 120 via a network connection 90. In one example, network connection 90 is the Internet. In other examples, the network connection 90 may be a phone network, a cable network, or other wireless or a wired networks.

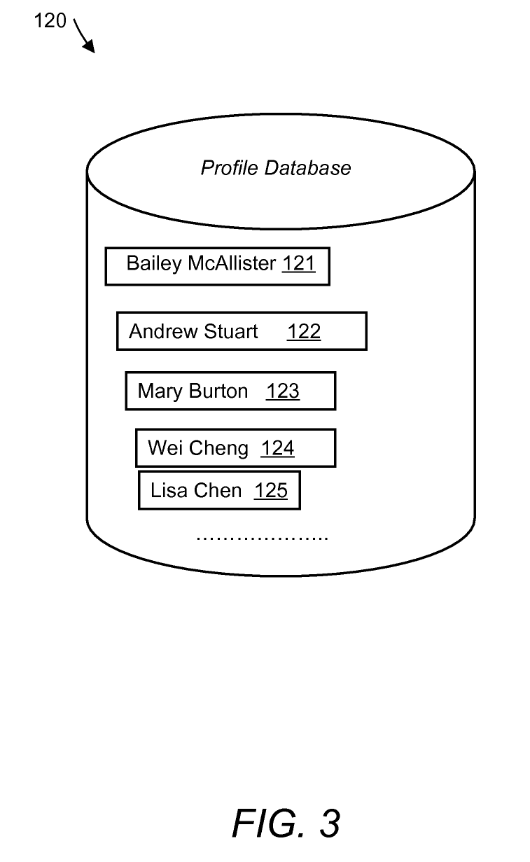

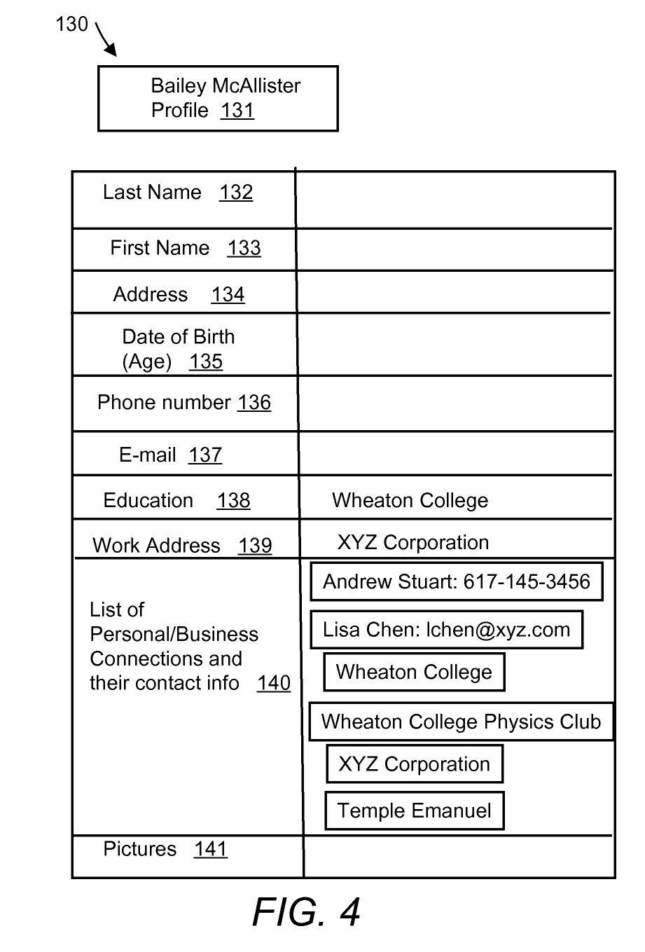

Database 120 includes personal data profiles of people. Examples of people whose profiles are listed in database 120 are people residing in a certain geographic area or people belonging to a certain organization or group, or in general all people on earth, as shown in FIG. 3. Database 120 also includes profiles of entities including businesses, educational institutions and organizations, among others. For every person or entity the system has a unique index preset and empty fields preserved for all attributes related to that person or entity. Referring to FIG. 4, the profile for Bailey McAllister 130 includes the unique preset index 131 and parameter fields for last name 132, first name 133, address 134, date of birth or age 135, phone number 136, education 138, work address 139, personal and/or business connections 140, pictures 141, among others. Basic information for each profile is preloaded by the system administrator based on publicly available data. Each profile has some basic identifiable information which allows people with some certainty to find any other person or an organization. These profiles are created before a first person comes in. The basic information is defined as information sufficient for identifying and matching a specific person with a specific profile. In one example, the basic information is a name and/or any of the other mentioned parameters. Publicly available data include data from phone directories, business directories, marketing data and financial data, among others. In other examples, other legally accessible data are also included. The basic profile information is published and then other people including the person to whom the profile belongs contribute, edit and modify the profile information. The real person who comes to the system is verified and is matched to his/her existing profile. A real person has only one profile matching to him. The system is structured in such a way that moderation of profile matching is done by the system or by other people. If, for some reason, a person cannot find his own profile in the system, the system allows creation of a new profile, but that profile is subject to verification. Similarly, every organization (schools, companies, etc.) has its own unique profile.

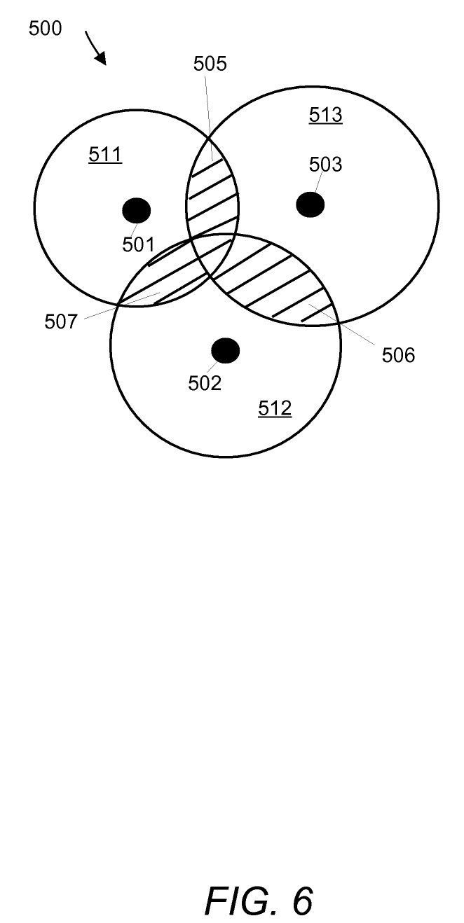

Referring to FIG. 6, individual persons 501, 502, 503 recall all their connections 511, 512, 513, respectively, that they had with other people and organizations and record this information to the system 100. As shown person 501 shares connections 505 with person 503 and connections 507 with person 502. Also, person 502 shares connections 506 with person 503. Thus persons 501, 502, 503 form a common matrix of connections comprising shared connections 505, 506, 507. In other words, people link existing profiles of real people and/or organizations according to real life connections. All connections that happened, happening or will happen are recorded. Even if some connection is lost or forgotten, by using this system, it can be restored and recorded because there are at least 2 persons in each connection and often there are many witnesses of an existing connection. A person can record own connections and can record connections of other people if there is a direct knowledge and a direct relationship. For example, a person can identify that another person had also studied at a certain school. Additional information can be recorded by people for other people. However, certain information can be accessed by everyone and some information can be only accessed by a few chosen people. Privacy settings are specified by the profile owner.

In the example of FIG. 4, Bailey McAllister's connections include her friends Andrew Stuart and Lisa Chen. Bailey McAllister also attended Wheaton College and was part of the Wheaton College Physics Club, so she is also connected to these organizations. She is also connected to XYZ Corporation where she works and to the religious group of Temple Emanuel. Initially, Bailey forgot about entering her connection to Wheaton College Physics Club. However, Andrew Stuart who was also part of the club remembered and added this connection information in the system. If a community group associated with a specific entity is not represented, a user may initiate the formation of the group, enter all information/names he is able to recall and publish the new group information. Other group members may then add, edit and expand the published group information. The system is used for recording past connections among people, form new connections among people sharing similar interests, or restore previous connections.

This unique feature of the system allows people to share knowledge about a person and their connections and record it to preset database fields of the person's profile. The profile index and the individual profile fields have unique locations, which can be searched and easily found. The system is self updated and the information is always current because people contribute to it and edit it. Since every piece of information has a unique location—once somebody changes it, all people can see the updated information because everyone is linked to the same index field of information. This web-based people directory system is a Web 2.0 website that combines the online social network attributes with the ability to contribute content and information while allowing users to exercise control over their data. Web 2.0 websites refer to web-based communities and hosted services, which facilitate creativity, collaboration and sharing between users. A more detailed discussion of Web 2.0 websites is presented in Wikipedia, http://en.wikipedia.org/wiki/Web_{—}2, the contents of which are incorporated herewith.

The web-based people social network system 100 functions as a common memory storage that allows people to record and preserve their memories—attributes of contact information, people connections, past events and biographical facts. Because other people can record information about a person, it allows people to memorialize facts about a person and recall something that would have been forgotten, since somebody may still remember it and record it in a proper information field.

Thus the common memory or connection knowledge database is created. A profile of every person and a profile of every organization is written by witnesses. People manage, fill in and sort existing database of all people. On collaborative basis people provide and share direct knowledge about connections, relations and life facts of other people. All information is moderated by people. All profiles' information can be accessed by public based on the profile's owner decision and preferences.

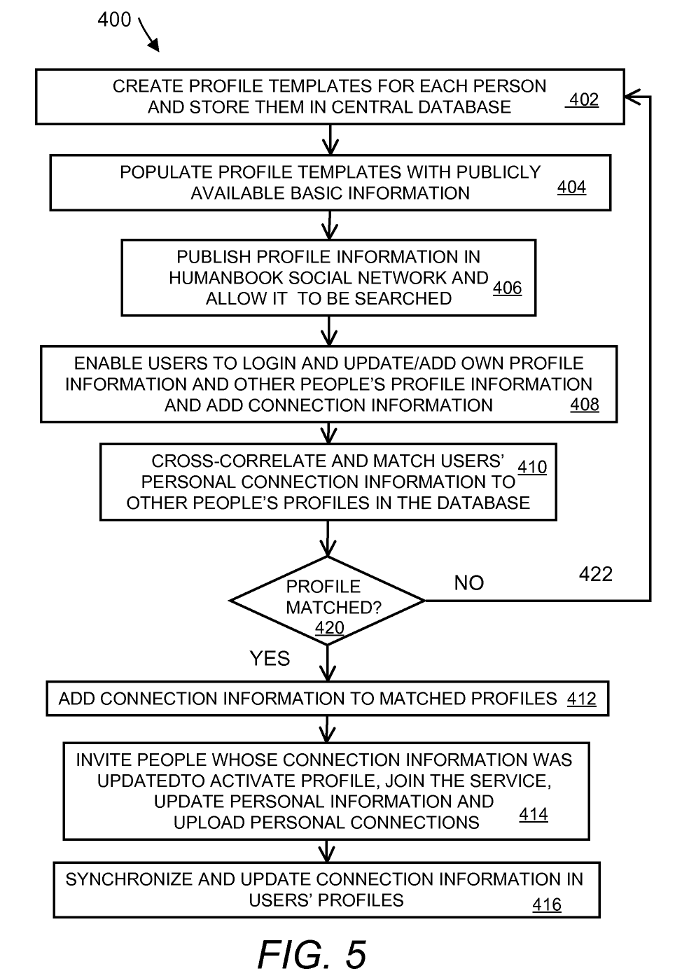

Referring to FIG. 5, the process 400 for generating a web-based social network database 100 includes the following steps. First, creating profile templates for each person on earth and storing these profile templates in a central database (402). Next, populating the profile templates with publicly available basic information (404) and then publishing the public profile information in the web-based directory (406) and allowing it to be searched. Users are allowed to login into the directory website, update their own and other people's profile information and upload their personal connections information (408). Next, the system cross-correlates and matches connection information retrieved from a user's personal connections field to other people's profiles in the database (410). This matching of the connection information to a person's profile is done automatically or manually by the user or the administrator. If a profile match is found (420) the connection information is added to the matched profile (412). The person whose connection information was added is invited to activate his profile, join the service, update personal profile information and upload his personal connections (414). The invitation may be sent by the system administrator, the user who entered the connection information or any other user. All submissions are eponymous and can be traced back to the originator of the information. Finally the system synchronizes and updates the entered/updated connection information is in all users' personal connections fields (414). If a profile match was not found in step 420 a new profile is created and added in the database (422). The system is governed by rules that do not allow publishing of negative information in a profile, i.e., all published information is positively bound. All profile information entries are verified either by other members of the community to which the specific person belongs or by answering preset questions formulated based on common knowledge. In one example, a person's attendance of a particular school is verified based on answering a question about a teacher who taught at the particular school during the time period of reference. In this example, the question may be either the name of the teacher or subject matter taught by the teacher, or a specific event that happened in the teacher's presence.

Furthermore, the system allows searching of the directory entries based on the various field parameters and main index and it provides accurate information easily and fast to those who need it and to those who are authorized to access it. Users with the same field parameters/attributes are matched and united in entities, groups or communities for communication purposes. The system also provides a platform and tools for communications and community group building.

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for an online social network comprising:
generating a profile template for each person within a group and storing them in a central database;
populating each person's profile template with publicly available information;
publishing each person's profile template through a web-based social network application executing on a first computing device and wherein said web-based social network application is adapted to be accessed by a first person of said group through a browser executing on a second computing device, wherein said second computing device is adapted to connect to said first computing device via a network connection;
providing a first webpage adapted to be viewed by said first person via said browser for said first person to login into said web-based social network application and to search said first person's own profile template in said central database;
retrieving said first person's own profile template and displaying it in a second webpage adapted to be viewed by said first person through said browser;
uploading said first person's personal social network information wherein said personal social network comprises names, contact information, pictures and stories of the first person's personal contacts;
adding said uploaded personal social network information to said first person's profile template; and
cross-correlating the uploaded personal social network information of the first person with information in profile templates of the first person's personal contacts and updating said personal contacts' profile templates.

2. The computer implemented method of claim 1 wherein said profile template comprises one or more fields comprising last name, first name, address, age, date of birth, phone number, e-mail address, education background, work address, personal address book, personal contacts and photographs.

3. The computer implemented method of claim 2 further comprising selecting one or more of said fields to be publicly displayed in said profile template.

4. The computer implemented method of claim 2 further comprising updating said first person's profile information by said first person.

5. The computer implemented method of claim 4 further comprising displaying the updated profile template and uploaded personal social network information of said first person in said second webpage.

6. The computer implemented method of claim 1 further comprising verifying and updating said first person's profile information by other persons of said group.

7. The computer implemented method of claim 5 further comprising updating said personal social network information of said first person's personal contacts in said first person's personal social network based on information in said personal contact's profile templates.

8. The computer implemented method of claim 1 further comprising inviting said first person's personal contacts to join said web-based social network application, verify information in their personal profile templates and then upload their personal social network information.

9. The computer implemented method of claim 1 further comprising generating a profile template for an uploaded personal contact of said first person when none exist in said central database.

10. The computer implemented method of claim 1 wherein said second computing device comprises one of a computer, a mobile phone, a pager, a television remote control, a PDA or combinations thereof.

11. The computer implemented method of claim 1 wherein said group comprises one of a group of people residing in a certain geographic area, a group of people belonging to a certain organization, or a group of all people on earth.

12. The computer implemented method of claim 1 wherein said publicly available information comprises data from one of telephone directories, business directories, marketing data, financial data or other legally accessible data.

13. The computer implemented method of claim 1 wherein each person's profile information is verified by answering preset questions formulated based on group common knowledge.

14. The computer implemented method of claim 2 further comprising grouping together into subgroups persons with the same field parameters.

15. The computer implemented method of claim 14 further comprising providing communication tools for communications between said persons within the group or said subgroups.

16. A computer system comprising a first computing device, a storage device, profile templates for each person on earth stored in a central database stored in said storage device and a web-based social network application stored in said storage device, wherein said web-based social network application comprises:
a first webpage adapted to be viewed by a first person through a browser executing on a second computing device, wherein said second computing device is adapted to connect to said first computing device via a network connection, wherein said first webpage prompts said first person to login into said web-based social network application and to search said first person's own profile template stored in said central database;
a second webpage displaying said first person's retrieved profile template and comprising means for said first person to update said first person's profile information, means for uploading said first person's personal social network information wherein said personal social network information comprises names, contact information, pictures and stories of the first person's personal contacts, means for adding said updated profile information and uploaded personal social network information to said first person's profile template, means for cross-correlating the uploaded personal social network information of the first person's personal contacts with information in profile templates of said first person's personal contacts and means for updating said personal contacts' profile templates.

17. An interactive web-based social network application stored in a first computing device and adapted to be accessed by a first person via a second computing device connecting to said first computing device via a network connection comprising:
a first webpage adapted to be viewed by said first person through a browser executing on said second computing device, wherein said first webpage prompts said first person to login into said web-based social network application and to search said first person's own profile template stored in a central database;
a second webpage also adapted to be viewed by said first person through said browser, wherein said second webpage displays said first person's profile template and comprises means for said first person to update said first person's profile information, means for uploading said first person's personal social network information wherein said personal social network information comprises names, contact information, pictures and stories of the first person's personal contacts, means for adding said updated profile information and uploaded personal social network information to said first person's profile template, means for cross-correlating the uploaded personal social network information of the first person's personal contacts with information in profile templates of said first person's personal contacts and means for updating said personal contacts' profile templates.

18. A display device comprising:
a first graphical user interface comprising a first row and a control and wherein said first row comprises a prompt to a first person to login into a web-based social network application and to search said first person's own profile template stored in a central database, and wherein actuation of said control initiates said searching and retrieval of the first person's profile template;
a second graphical user interface comprising one or more rows displaying said first person's retrieved profile template and additional controls and wherein activation of said additional controls allows said first person to update information in said first person's profile template, to upload said first person's personal social network information wherein said personal social network information comprises names, contact information, pictures and stories of the first person's personal contacts, to add said updated profile information and uploaded personal social network information to said first person's profile template, to cross-correlate the uploaded personal social network information of the first person's personal contacts with information in profile templates of said first person's personal contacts and to update said personal contacts' profile templates.
